(19) United States
(12) Patent Application Publication
(10) Pub. No.: US 2009/0176933 A1
(43) Pub. Date: Jul. 9, 2009

(54) Method For Production Of Polyester Resins Containing Nanodispersed Nanoscale Additives As Binders For Coating Powers

(76) Inventors: Dieter Holzinger, Wels (AT); Thomas Schmidt, Wels (AT)

Correspondence Address: K.F. ROSS P.C., 5683 RIVERDALE AVENUE, SUITE 203 BOX 900, BRONX, NY, 10471-0900, US

(21) Appl. No.: 11/988,123

(22) PCT Filed: Jun. 19, 2006
(86) PCT No.: PCT/AT2006/000250

§ 371 Date: Jan. 19, 2009

(30) Foreign Application Priority Data
Jun. 28, 2005 (AT) A 1092/2005

(51) Int. Cl. C08F 2/44; C08K 3/10; C08K 3/34; C08L 67/00

(52) U.S. Cl. 524/781; 524/780; 524/786; 524/789; 524/845

(57) ABSTRACT

The invention relates to a method for production of polyester resins containing nanodisperse nanoscale additives as binder for powder paints, whereby firstly at least one precursor compound for nanoscale solid particles to be formed is added to the reaction starting materials during the resin synthesis and distributed in the reaction starting materials. The precursor compound(s) which may be reacted at a temperature between 30′ and 260° C., preferably between 80° and 250° C., are reacted to give the desired nanoscale solid particles under the effect of a reaction temperature in the range between 30′ and 260° C., preferably between 80′ and 250° C., the nanoscale solid particles thus formed being nanodispersedly distributed in the polyester resin.

The present invention relates to a method of making polyester resins containing nanodispersed nanoscale additives as binders for coating powders.

Coating powders have become widely used for the coating materials like metal, glass, ceramics, etc. due to the great cost efficiency of the method and its favorable assessment from the standpoint of environmental protection.

In the past, a large number of different binder systems, pigments, fillers and additives have opened up a wide variety of applications for coating powders. For example, decorative coatings, anti-corrosion systems, heat-resistant coatings, weatherproof varnishes for facades and vehicles and a variety of functional coatings with a glossy to matte and smooth to structured finish have long been known in the prior art. It is notable that polyester resins have particular importance among the binder systems used, attributable to their balanced profile of properties without any particular weaknesses.

Polyester resins as binders for coating powders have been known in the prior art for over 30 years. Thus, for example, DE 21 63 962 A1 and DE 26 18 729 A1 describe carboxyl-functional polyester resins in the acid number range of 30-100 or 50-100 mg KOH/g resin, which can be cross-linked with polyepoxide compounds such as epoxide resins based on bisphenol A and epichlorohydrin or even triglycidyl isocyanurate. Similarly early examples for hydroxyfunctional polyester resins as binders for coating powders are provided by NL 72 01 656 A. The polyester resins disclosed in the examples have hydroxyl numbers from 124 to 160 mg KOH/g resin; the resins are cross-linked through reaction with blocked polyisocyanurates.

More recent prior art shows a trend toward polyester resins that have a lesser requirement for hardeners due to lower parameter values. Thus, for example, EP 0 107 888 B1 and EP 0 110 450 B1 disclose polyester resins with acid number ranges from 10 to 26 or 10 to 30 mg KOH/g resin, respectively.

Qualitative differences are also noted. For example, according to EP 0 664 325 B1, a lower isophthalic acid content in the resins leads to increased resistance of the coating powders produced therefrom against physical aging of the films. On the other hand, high isophthalic acid contents result in increased weather stability for the coatings produced therefrom, as disclosed in EP 0 389 926 B1 and DE 43 35 845 C2. In this way, polyesters as binders for coating powders make it possible to produce a wide range of different qualities of coating powders.

As a result of the increasing availability of nanoscale solid substances—substances with a characteristic particle size <1 μm and preferably <0.1 μm—that are able to impart varied and previously unattained characteristics to the materials containing them based on highly specific property profiles, there is the possibility of preparing coating powders with other specific properties that did not exist before then and thus to open up entirely new kinds of applications for them. Examples of coating powders that contain nanoparticles are supplied, for instance, by BP 1 164 159 A1, EP 1 361 257 A1 and WO 02/051922 A2. However, no more detailed teaching about the type and form of dispersion of the nanoparticles in the coating powders can be derived based on the prior art disclosed in these documents, and moreover these disclosures do not at all deal with the problems of irregular and incomplete dispersion of the nanoparticles in the coating powders.

WO 2005/075548 A2, or AT 413 699 B1, provides a detailed overview of quality traits which can be introduced into coatings by means of different nanoparticles.

Coatings with nanodispersed nanoscale particles consisting of compounds of the elements silver or copper, or of the metals themselves in their elemental form, have biocidic effects due to a small but persistent presence of silver or copper ions on their surface. The use of nanodispersed nanoscale oxidic particles of the elements silicon, aluminum, zirconium and titanium leads to increased hardness and scratch-resistance in coatings. Moreover, this titanium dioxide—as well as zinc oxide—is also known as an UV absorber, and in addition it has a photochemical effect.

In WO 2005/075548 A2, it was found that the introduction of dry nanoparticulate material in coating powder formulations results in suboptimal dispersion of these particles in the coating powders, which is likely attributable mainly to the fact that nanoparticles introduced in dry form are generally present overwhelmingly in agglomerated form and rarely as primary particles.

Significantly more favorable conditions in terms of their nanoparticulate character are present in nanoparticles introduced in suspension. WO 2005/075548 A2 describes a production method in which such nanoparticles dispersed in fluid are added in the synthesis of polyester resins as binders for coating powders. In this case, the largely nanodispersed distribution of those particles in such suspensions is maintained in the course of the polyester synthesis. The coating powders produced using such polyesters have much greater efficacy, in terms of the specific properties of the nano-materials used, than do coating powders in which the corresponding nano-materials are added to the coating powder components as dry material, mixed in dry form and homogeneously dispersed by extrusion.

Nonetheless, the method above also has certain deficiencies. For one, there is the limitation that the fluids of those suspensions must be compatible with the formulation and synthesis of a polyester resin as a binder for coating powders. While that is generally true of water as a continuous-phase of such suspensions, it can be quite costly if large quantities of water, that can get into the starting material of a polyester resin in this way, must be distilled off from it before the actual synthesis reaction. If the respective nanoparticulate solid particles are dispersed in a glycol, then qualitative as well as quantitative restrictions are preprogrammed: not all glycols are equally suited to making polyester resins as binders for coating powders, and even for those that are suited, there are in any case upper limits on the quantity to be added, that are set by the resin formulation aimed for.

Another problem not to be underestimated is those substances that are added to those suspensions in order to prevent the contained nanoparticles from accreting into larger agglomerates and to keep such suspensions stable long-term as far as possible. In general, these additives are based on highly specific know-how of the makers of such suspensions, which is not revealed in product information. However, it has been shown that such additives—no matter how effective they may be in the stabilization of the suspensions—can impede the resin synthesis or harm the intended resin quality.

Finally, it should be noted that the commercial suspensions of nanoparticulate solid materials are generally very expensive. That frequently causes a very significant increase in the cost of polyester resins in which such nanoparticles are incorporated.

Thus there is a need for a method that makes it possible to introduce nanoscale solid particles in a nanodispersed manner in a polyester resin as a binder for coating powders, without it being necessary to introduce large quantities of fluid, as the case may be, into the polyester synthesis. In addition, there is need for a method that makes it possible to introduce nanoscale solid particles in a nanodispersed manner into a polyester resin as a binder for coating powders, while at the same time forgoing suspensions containing additives, intended to ensure the stability of these suspensions, that are frequently undeclared and, perhaps, impede the resin synthesis process and/or harm the resin quality aimed for. In addition, there is a need for polyester resins as binders for coating powders that contain nanoscale solid particles in a nanodispersed manner, without moving into a price scale that is entirely different than that of conventional polyester resins.

Surprisingly, it was discovered that polyester resins containing nanoscale solid particles in a stable nanodispersed state can be produced as binders for coating powders, when, according to the method of the invention, initially at least one precursor compound to nanoscale solid particles to be formed, that is miscible with the reaction starting materials, is introduced into the reaction starting materials in the course of the resin synthesis and is dispersed in the reaction starting materials and that the precursor compound(s) capable of being reacted at a temperature between 30° and 260° C., preferably between 80° and 250° C., is(are) reacted under the influence of synthesis temperature in the range between 30° and 260° C., preferably between 80° and 250° C., resulting in formation of the desired nanoscale solid particles, with the nanoscale solid particles thus produced being distributed in a nanodispersed manner in the polyester resin.

The concept of “miscible with the reaction starting materials” in relation to a precursor compound also encompasses the notion that the precursor compound can also be soluble in the reaction starting materials.

Further traits and advantageous embodiments of the invention are described in dependent claims 2 to 14 and can be found in the following description.

These precursor materials are chemical compounds that contain the chemical element(s) of which the desired nanoscale solid particles are composed, and that can be dispersed initially based on corresponding miscibility/solubility in the starting material mixture for producing the polyester resin, before they are reacted under the influence of synthesis temperature and, as the case may be, also under the influence of small portions of water that have been added to the starting materials or are present anyway as water of reaction during a majority of the time of synthesis, with resulting formation of the desired nanoscale solids. In order for chemical compounds to be suited as precursor materials for the inventive production of nanoscale solid particles nanodispersed in the polyester resin, their reaction temperature must be within the range of about 30° and 260° C., preferably 80°-250° C. The nanoscale nature of the solid particles thus produced in polyester resins as binders for coating powders, as well as their nanodispersion in these resins, was proven by electron-microscopic examination of the resins produced according to this method.

The character of the chemical compounds used as precursor materials depends on the nature of the particles to be produced.

Besides having a reaction temperature within the above-described range of about 30° to 260° C., preferably 80-250° C., availability plays a significant role.

To produce polyester resins as binders for coating powders that contain nanoscale metal particles like copper or silver, or metals more precious than those mentioned, e.g. gold or other precious metals, in a nanodispersed manner, preferably salts of these metals with organic acids, especially (hydroxy-) carbonic acids, are used. Thus additions of silver citrate, copper citrate, copper oxalate or copper gluconate to the starting materials of the respective polyesters lead to the corresponding resins that contain the respective metal in the form of nanodispersed nanoscale particles. Electron-microscopic examinations have proven that the particles generated in the course of the resin synthesis are indeed nanoscale particles that are present in a nanodispersed manner in the resin matrix. The advantage of the use of the corresponding metal carboxylates lies in the circumstance that their acid residues are closely analogous to the (hydroxy-) carbonic acids used in the synthesis of the corresponding polyesters.

If organic salts are not commercially available, as in the case of gold, it is also possible to use inorganic materials such as chloroauric acid.

To produce polyester resins as binders for coating powders that are intended to contain nanoscale oxidic particles of the elements silicon, titanium, zirconium, aluminum, vanadium and/or tin, the salts of organic acids can also be used as a starting basis, if available, such as tin oxalate in the case of tin. Otherwise, one can advantageously start from the alkoxylates of the respective elements. For some of these elements it is advantageous or necessary to limit the hydrolytic sensitivity of commercially available precursor materials through complexing—for example, addition of (hydroxy-) carbonic acids like citric acid, and/or diketones, including their derivatives, such as acetylacetone—in such a way that a homogenous dispersion of that precursor material in the resin starting material is possible prior to the formation of the respective nanoparticles through the influence of increased temperature and, as the case may be, wetness. Of course, it is also possible within the scope of the invention to use combinations of complexing agents.

The alkoxylates are characterized by the general formula RₙX(OR′)ₘ₋ₙ, in which:
X=Si, Ti(IV), Zr(IV), Al, Va(III), Va(V)
R=a non-hydrolyzable substituent, perhaps furnished with one or more functional group(s), such as epoxy, hydroxyl, carboxyl
m=5 for Va(V); =4 for Si, Ti(IV), Zr; =3 for Al, Va(III)
n=[0≦n≦(m−2)]
R′=alkyl

Alkyl can preferably be methyl, ethyl, propyl, i-propyl, n-butyl, i-butyl, tert. butyl.

In this way, oxides and/or oxyhydrates of the mentioned elements can be produced in the form of nanoscale particles that, as the case may be (n>0), are surface-modified by organic substituents. Of course, it is possible within the scope of the present invention to use more than one precursor material in the course of the resin synthesis.

Again in the case of the oxidic nanoparticles nanodispersed according to the invention in the course of the polyester synthesis, it was possible to verify the particle fineness and dispersion in the resin by means of electron microscopy.

The invention is described in greater detail hereafter using the following examples. They are intended to aid in explaining the essence of the subject matter of the invention in greater detail, without limiting it in any way.

### EXAMPLE 1

By analogy with DE 21 63 962 A1, 241.08 g of 2,2-dimethylpropandiol 1,3, 18.63 g of ethylene glycol and 10 g of silver citrate are placed in a 1-liter reaction vessel equipped with a stirrer blade, temperature sensor, partial reflux column, distillation bridge and inert gas feed tube (nitrogen), and are liquefied with the addition of 10 g water and heating to a maximum of 100° C. under a nitrogen atmosphere. Under stirring, 361.35 g of terephthalic acid and 32.88 g of adipic acid, as well as 0.1% with respect to the total amount of the finished resin of a tin-containing catalyst, are then added, and the temperature of the reaction mass is increased in steps to 240° C., with a darkening of the resin starting materials occurring from about 150° C. The reaction is continued at this temperature until no further distillate is produced. Afterward, esterification is continued under reduced pressure, about 400 mbar, until the acid number of the hydroxyfunctional polyester resin is about 7 mg KOH/g polyester resin.

Then the temperature in the reaction vessel is reduced to 195° C. and 76.86 g of trimellitic acid anhydride are added. After one-and-a-half hours of stirring at about 195° C., the resin is poured out into a metal cup. The cooled resin according to Example 1 ultimately has the following parameters: acid number 70.8 mg KOH/g polyester hydroxyl number 10.3 mg KOH/g polyester.

A subsequent examination of the polyester using a transmission electron microscope shows the presence of individual spherical (silver) particles, of which 90% by number have a size of 58+/−28 nm.

### EXAMPLE 2

Analogously to Example 1, the same materials are used in the same quantities, but instead of the 10 g of silver citrate, 17.48 g of copper citrate are used. Commencing at about 200° C., a change in the color of the resin starting material is observable, which goes from blue to muddy green and brown to reddish black. The esterification is continued initially under normal pressure and then under reduced pressure (˜400 mbar) until the acid number of the hydroxyfunctional polyester resin is about 8 mg KOH/g polyester resin.

This hydroxylated polyester resin is then reacted with trimellitic acid anhydride according to Example 1, and ultimately has the following parameters: acid number 75.0 mg KOH/g polyester, hydroxyl number 6.6 mg KOH/g polyester.

A subsequent examination of the polyester using a transmission electron microscope shows the presence of individual spherical (copper) particles, of which 90% by number have a size of 31+/−8 nm.

### EXAMPLE 3

Analogously to Example 1, the same materials are used in the same quantities, but instead of the 10 g of silver citrate, 16.42 g of copper oxalate are used. Commencing at about 237° C., a change in the color of the resin starting material is observable, which goes from blue to muddy green and brown to reddish black. The esterification is continued initially under normal pressure and then under reduced pressure (˜400 mbar) until the acid number of the hydroxyfunctional polyester resin is about 4 mg KOH/g polyester resin.

This hydroxylated polyester resin is then reacted with trimellitic acid anhydride according to Example 1, and ultimately has the following parameters: acid number 69.6 mg KOH/g polyester, hydroxyl number 11.4 mg KOH/g polyester.

### EXAMPLE 4

Analogously to Example 1, the same materials are used in the same quantities, but instead of the 10 g of silver citrate, 24.09 g of copper gluconate are used. Commencing at about 140° C., a change in the color of the resin starting material is observable, which goes from greenish blue to colorless. After about 180° C. the starting material turns dark and finally becomes reddish black. The esterification is continued initially under normal pressure and then under reduced pressure (˜400 mbar) until the acid number of the hydroxyfunctional polyester resin is about 9 mg KOH/g polyester resin.

This hydroxylated polyester resin is then reacted with trimellitic acid anhydride according to Example 1, and ultimately has the following parameters: acid number 75.5 mg KOH/g polyester, hydroxyl number 3.5 mg KOH/g polyester.

### EXAMPLE 5

Analogously to Example 1, the same materials are used in the same quantities, but instead of the 10 g of silver citrate and instead of the water, 24.60 g of a 0.0106-mole aqueous solution of chloroauric acid (Merck) are used. Commencing at about 110° C., a change in the color of the resin starting material is observable, which goes from yellow to reddish. The esterification is continued initially under normal pressure and then under reduced pressure (˜400 mbar) until the acid number of the hydroxyfunctional polyester resin is about 7 mg KOH/g polyester resin.

This hydroxylated polyester resin is then reacted with trimellitic acid anhydride according to Example 1, and ultimately has the following parameters: acid number 73.1 mg KOH/g polyester, hydroxyl number 11.3 mg KOH/g polyester.

### EXAMPLE 6

Analogously to Example 1, the same materials are used in the same quantities, but instead of 10 g of silver citrate, 11.35 g of tin oxalate are used. Commencing at-about 170° C., a slight development of foam is observable in the resin starting material, caused by the decomposition of the tin oxalate. The esterification is continued initially under normal pressure and then under reduced pressure (˜400 mbar) until the acid number of the hydroxyfunctional polyester resin is about 8 mg KOH/g polyester resin.

This hydroxylated polyester resin is then reacted with trimellitic acid anhydride according to Example 1, and ultimately has the following parameters: acid number 73.0 mg KOH/g polyester, hydroxyl number 5.7 mg KOH/g polyester.

A subsequent examination of the polyester using a transmission electron microscope shows the presence of individual spherical (tin oxide) particles, of which 90% by number have a size of 12+/−2 nm.

### EXAMPLE 7

241.08 g of 2,2-dimethylpropandiol 1,3 and 18.63 g of ethylene glycol are placed in a 1-liter reaction vessel equipped with a stirrer blade, temperature sensor, partial reflux column, distillation bridge and inert gas feed tube (nitrogen), and are liquefied with the addition of 20 g water and heating to a maximum is of 80° C. under a nitrogen atmosphere. Under stirring, 361.35 g of terephthalic acid, 32.88 g of adipic acid, 0.1% with respect to the total amount of the finished resin of a tin-containing catalyst, and 11.20 g of tetraethoxysilane are then added in succession, in such a way that the tetraethoxysilane is added at a temperature of about 60° C. The temperature of the reaction mass is then increased in steps to 240° C. The reaction is continued at this temperature until no further distillate is produced. Afterward, esterification is continued under reduced pressure, about 400 mbar, until the acid number of the hydroxyfunctional polyester resin is about 7 mg KOH/g polyester resin.

This hydroxylated polyester resin is then reacted with trimellitic acid anhydride according to Example 1, and ultimately has the following parameters: acid number 72.0 mg KOH/g polyester, hydroxyl number 11.2 mg KOH/g polyester.

A subsequent examination of the polyester using a transmission electron microscope shows the presence of individual spherical (silicon dioxide) particles, of which 90% by number have a size of 7+/−3 nm.

### EXAMPLE 8

In an Erlenmeyer flask, 25.62 g of citric acid are dissolved at room temperature in 136.71 ml of water. Then 19.85 g of titanium acetylacetonate and 0.96 g of 3-(triethoxysilyl)propyl-succinic acid anhydride are added and stirred for 30 minutes. The resulting solution is designated thereafter as “Solution 1.”

A 1-liter reaction vessel equipped with a stirrer blade, temperature sensor, partial reflux column, distillation bridge and inert gas feed tube (nitrogen) is filled with 194.01 g of 2,2-dimethylpropandiol 1,3 and 7.80 g of 1,5-pentanediol and 20.31 g of hydroxypivalinic acid neopentyl glycol ester that are liquefied with the addition of “Solution 1” and heating to a maximum of 80° C. under a nitrogen atmosphere. With stirring, 230.76 g of terephthalic acid and 0.1% with respect to the total amount of the finished resin of a tin-containing catalyst are then added in succession. The temperature of the reaction mass is then increased in steps to 240° C. The reaction is continued at this temperature until no further distillate is produced. After cooling to 220° C., 81.34 g of isophthalic acid and 12.00 g of adipic acid are added in succession, and after the additions the temperature is increased again to 240° C. The reaction is continued at this temperature until no further distillate is produced. Afterward, esterification is continued under reduced pressure, about 200 mbar, until the acid number of the carboxyfunctional polyester resin is 45.6 mg KOH/g polyester resin. (hydroxyl number 2.8 mg KOH/g polyester).

A subsequent examination of the polyester using a transmission electron microscope shows the presence of individual spherical (titanium oxide) particles, of which 90% by number have a size of 30+/−10 nm.

### Example 9

In an Erlenmeyer flask, 22.20 g of oxalic acid dihydrate are dissolved at room temperature in 140.00 ml of water. Then 7.52 g of acetylacetone and 25.00 g of zirconium n-butoxide are added and stirred for 90 minutes. The resulting solution is designated thereafter as “Solution 2.”

A 2-liter reaction vessel equipped with a stirrer blade, temperature sensor, partial reflux column, distillation bridge and inert gas feed tube (nitrogen) is filled with 446.16 g of 2,2-dimethylpropandiol 1,3, 10.4 g of 1,5-pentanediol, 37.3 g of ethylene glycol and 40.62 g of hydroxypivalinic acid neopentyl glycol ester that is liquefied with the addition of “Solution 2” and heated to a maximum of 80° C. under a nitrogen atmosphere. With stirring, 637.8 g of terephthalic acid and 0.1% with respect to the total amount of the finished resin of a tin-containing catalyst are then added in succession. The temperature of the reaction mass is then increased in steps to 240° C. The reaction is continued at this temperature until no further distillate is produced. Afterward, esterification is continued under reduced pressure, about 400 mbar, until the acid number of the hydroxyfunctional polyester resin is about 7 mg KOH/g polyester resin.

Then, as described in Example 1, 153.7 g of trimellitic acid anhydride are added and stirred in for 75 minutes at 195° C. The resulting resin had the following parameters: acid number 71.9 mg KOH/g polyester, hydroxyl number 12.2 mg KOH/g polyester.

A subsequent examination of the polyester using a transmission electron microscope shows the presence of individual spherical (zirconium oxide) particles, of which 90% by number have a size of 8+/−4 nm.

1. A method of making polyester resins containing nanodispersed nanoscale solid particles as binders for coating powders, wherein initially at least one precursor compound to nanoscale solid particles to be formed, that is miscible with the reaction starting materials, is introduced into the reaction starting materials in the course of the resin synthesis and is dispersed in the reaction starting materials and that the precursor compound(s) capable of being reacted at a temperature between 30 and 260° C., preferably between 80 and 250° C., is(are) reacted under the influence of synthesis temperature in the range between 30° and 260° C., preferably between 80° and 250° C., resulting in formation of the desired nanoscale solid particles, with the nanoscale solid particles thus produced being distributed in a nanodispersed manner in the polyester resin.

2. The method of claim 1 wherein the precursor compound(s) are introduced in the beginning phase of the resin synthesis.

3. The method of claim 1 wherein the reaction of the precursor compound(s) is carried out under the influence of water portions added to the reaction starting materials or in the presence of water of reaction present during the time of synthesis.

4. The method of claim 1, wherein organic or inorganic metal or metalloid compounds are used as precursor compounds.

5. The method of claim 4 wherein copper, silver, titanium, zirconium, aluminum, vanadium, tin and/or silicon compounds are used as precursor compounds.

6. The method of claim 4 wherein precious metal compounds, e.g. (currently amended) gold compounds, are used as precursor compounds.

7. The method of claim 4 wherein metal or metalloid salts of organic acids, particularly (hydroxy-) carbonic acids, are used as precursor compounds.

8. The method of claim 7 wherein metal or metalloid citrates, oxalates or gluconates are used as precursor compounds.

9. The method of claim 4 wherein metal or metalloid alkoxylates are used as precursor compounds.

10. The method of claim 9 wherein the metal or metalloid alkoxylates that can be used as precursor compounds correspond to the general formula RₙX(OR′)₋ₙ in which
X=Si, Ti(IV), Zr(IV), Al, Va(III), Va(V)
R=a non-hydrolyzable substituent, perhaps furnished with one or more groups, for example epoxy, hydroxyl, carboxyl
m=5 for Va(V); =4 for Si, Ti(IV), Zr; =3 for Al, Va(III)
n=[≦n≦(m−2)]
R′=alkyl.

11. The method of claim 9 wherein one or more complexing agents are added to the metal or metalloid alkoxylates that can be used as a precursor compound, in order to limit their hydrolytic sensitivity.

12. The method of claim 11 wherein diketones, including their derivatives such as acetylacetone, is/are used as complexing agents.

13. The method of claim 11 wherein (hydroxy-) carbonic acids are used as completing agents.

14. The method of claim 13 wherein the (hydroxy-) carbonic acid is citric acid.
